(19) United States
(12) Patent Application Publication
(10) Pub. No.: US 2015/0052060 A1
(43) Pub. Date: Feb. 19, 2015

(54) Plagiarism Protection

(71) Applicants: Wolfgang Klasen, Ottobrunn (DE); Angela Schattleitner, Tuntenhausen (DE)

(72) Inventors: Wolfgang Klasen, Ottobrunn (DE); Angela Schattleitner, Tuntenhausen (DE)

(21) Appl. No.: 14/348,476

(22) PCT Filed: Sep. 3, 2012
(86) PCT No.: PCT/EP2012/067132

§ 371 Date: Mar. 28, 2014

(30) Foreign Application Priority Data
Sep. 30, 2011 (DE) DE 10 2011083828.

(51) Int. Cl. G06Q 30/00

(52) U.S. Cl. CPC G06Q 30/0185; G06Q 2220/16
USPC 705/57

(57) ABSTRACT

The embodiments relate to methods for plagiarism protection for cryptographic challenge-response methods, wherein an originality test for products that require a secret symmetric or private asymmetric key on the product side is carried out such that a plagiarism protection service is set up as a web service that carries out a calculation of the challenge for the product to be tested and a verification of the response for the product and sends the result of the verification in an integrity-protected manner to a testing unit authorized for plagiarism testing, and which, if the cryptographic challenge-response method is not present on the product to be tested after the key has been authenticated and authorized by the product to be tested, can subsequently send software for calculating the response directly to the product online.

### CROSS-REFERENCE TO RELATED APPLICATIONS

The present patent document is a §371 nationalization of PCT Application Serial Number PCT/EP2012/067132, filed Sep. 3, 2012, designating the United States, which is hereby incorporated by reference, and this patent document also claims the benefit of DE 10 2011 083 828.7, filed on Sep. 30, 2011, which is also hereby incorporated by reference.

### TECHNICAL FIELD

The embodiments relate to methods and arrangements where an originality check is carried out to identify plagiarisms.

### BACKGROUND

For commercial reasons, manufacturers of cheap products increasingly copy high-quality branded products. External features and the identification features are imitated in such a way that a layman recognizes no difference compared with the branded product. On the whole, plagiarisms result in substantial commercial loss for the manufacturers of high-quality branded products. In addition, security problems and liability issues may arise.

Dynamic protocols are increasingly used for an originality check. Dynamic protocols offer a high degree of protection against unauthorized copying of originality features. Symmetric and asymmetric challenge-response methods, for example, are suitable. Such challenge-response methods are implemented on radio-frequency identifications (RFIDs) or RFID reading devices for ease of use. A challenge-response method is a secure knowledge-based user authentication method. Here, one user sets a challenge that the other user must resolve by calculating a response. The challenge is intended to prove that the other user knows specific information without transferring the information again. This method is frequently used in passport authentication systems.

Challenge-response methods that require a secret symmetric or a private asymmetric key on the component side are frequently used for an originality check. If no release of the key by a user is provided in automated applications, the required keys are stored in a memory area of the component protected against unauthorized reading. The cryptographic functions are implemented on both the component and the checking device. However, a challenge-response method is not supported by standard RFID tags and standard RFID reading devices according to ISO/IEC 15961 and 15962.

While the secure challenge-response protocol may be implemented based on the secure connection of the device to be protected to a special crypto-RFID chip, the checking function would normally have to be implemented on the reading device side using software that is locally integrated into the reading device. The reading device also normally requires a secure key memory to check the response.

### SUMMARY AND DESCRIPTION

The scope of the present invention is defined solely by the appended claims and is not affected to any degree by the statements within this summary. The present embodiments may obviate one or more of the drawbacks or limitations in the related art.

The object of the embodiments is to provide a method for plagiarism protection checking with which, using a reading device, a plagiarism protection check may be carried out, along with a secure provision for software that is not provided but is required on the reading device or on the product and is necessary to carry out the method.

Embodiments are based on the realization that, by a global web service, a plagiarism protection service may be provided, wherein not only may the verification of a product be carried out when a challenge-response solution is requested, but also the plagiarism protection is supported through the online provision of the missing software.

It is generally proposed to set up a plagiarism protection service as a web service, wherein the technology is disclosed to the customers with which the customers may protect their products that are to be monitored or verified.

It is proposed to carry out the calculation and the provision of a challenge and also the verification of the response with the global web service, and transfer the result via an authenticated and integrity-protected communication connection to a device authorized for plagiarism protection checking.

A device of this type may, for example, be a checking device, in particular a RFID reading device.

Furthermore, it may advantageously be pointed out that, by the plagiarism protection service that is offered as a web service, the result of the verification of the response is transferred to a third-party checking body authorized for plagiarism protection checking. In conjunction therewith, a transfer of environmental data may be carried out, wherein the environmental data may include, for example, a serial number, a manufacturer, a location, the date or the verification result. Further data may be included as the environmental data.

The keys required for the method are stored in a memory area of the corresponding product protected against unauthorized reading.

A request may advantageously be calculated by the plagiarism protection service immediately at the request of a product. To do this, depending on the type of the challenge-response method, the public key certificate, a private key or the secret key for a UID (Universal Identifier) of the product is provided in a repository adequate for the plagiarism protection service, a central memory.

An authentication and an authorization of the product vis-à-vis the plagiarism protection service is advantageously carried out. However, the authentication and authorization may be carried out using built-in standard methods, such as, for example, Secure Sockets Layer (SSL) with mutual authentication.

Responses may be transferred immediately back to the web service and verified. Alternatively, a response may also be temporarily stored by a checking device, such as, for example, an RFID reading device, a control device, or a checking computer, and may then be transferred online or offline via data media to the plagiarism protection service and verified at time intervals by the plagiarism protection service.

In order to generate a response, the authenticity of the plagiarism protection service and the software stored in the plagiarism protection service are checked. This means that the authenticity of the software is checked before being run.

In order to verify the response transferred to the plagiarism protection service, the plagiarism protection service similarly calculates the response using the product key and compares the response with the response transmitted to the plagiarism protection service. If the two responses match one another, the product may be regarded as authentic within the meaning of the plagiarism protection service.

The plagiarism protection service may provide authorized bodies, such as, for example, a brand manufacturer registered with the service, with a portal via that the authorized body has access to the results of the plagiarism protection checks carried out.

It is also advantageous to implement the method using cryptographically secured RFID chips. Standard RFID tags and standard RFIDs do not support currently conventional software. In one respect, software required in order to read, for example, an RFID tag may be downloaded from the plagiarism protection service. This offers particular advantages in that, if further data are available, an environmental check may be carried out for the component whose originality is to be checked.

Brand manufacturers may advantageously be offered portals in which evaluations of originality checks hitherto carried out may be retrieved. The results of the plagiarism protection check may equally be read by retrieving the results via standard interfaces. By these individually specified features, manufacturers of branded products may arrange for originality checks to be carried out in a secure manner by corresponding providers.

### BRIEF DESCRIPTION OF THE DRAWINGS

FIG. 1 depicts an embodiment of a plagiarism protection service 1 and a reading device 2 and a product 3 to be tested, wherein a communication takes place between the individual components via web interfaces 11, 12 or via a checking interface 13.

FIG. 2 depicts a representation according to the prior art, wherein a checking interface 13 is defined by compatible software between a reading device 2 and a product 3.

### DETAILED DESCRIPTION

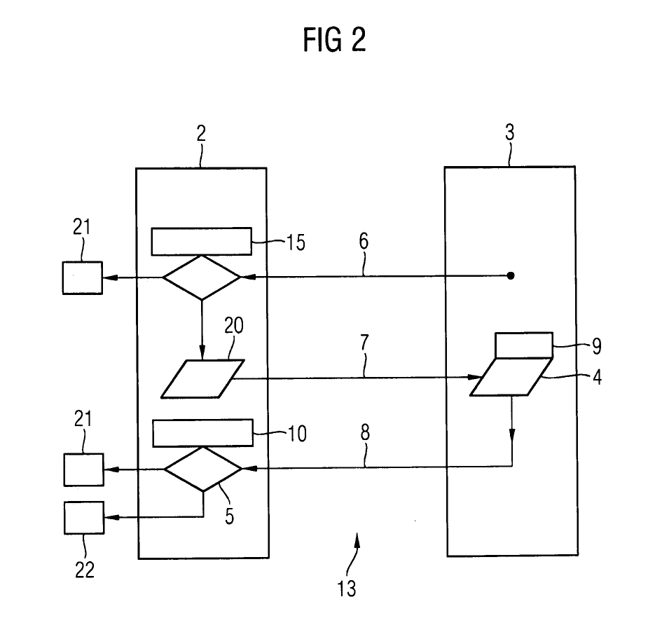

FIG. 2 depicts a prior art that is designed to carry out a plagiarism protection check for cryptographic challenge-response methods. In this case, a secret symmetric or private asymmetric cryptographic key 9 is provided on the component side. Cryptographic functions are provided both on the side of the product 3 and on the side of the checking device 2. However, methods of this type are not supported by standard RFID tags and corresponding reading devices.

This means that a product 3 to be tested may not communicate with the checking device 2 without additional integration of checking functions into the checking device 2.

While the implementation of the secure challenge-response protocol takes place on the RFID chip in hardware, an implementation on the side of the reading device may take place in software.

If a certificate 6 is then sent from a product 3 to be checked to the reading device, for example a public key or signature, a challenge is generated in the reading device. The generation 20 of the challenge takes place in the checking device where the calculated challenge 7 is sent to the product 3. The generation 4 of the response 8 takes place on the product 3 to be checked, for example in an RFID tag. The response 8 is transferred to the checking device 2 and decrypted with a public key 10 for verification 5 of the response 8. A verification of the product 3 to be checked may already take place on receipt of the certificate 6, so that, in connection with the public key 15, a decision, e.g. of “false” 21, may be made. On receipt of the certificate 6 on the reading device 2, the continuation is decided by the challenge-response method, wherein the challenge 7 is sent to the object 3 to be checked, which calculates and returns a response 8. The verification 5 of the response 8 results in a categorization of the product as “false” 21 or “true” 22.

Plagiarism protection may involve the unique identification of a component or unit as an original component of a specific manufacturer. The use of RFID here is merely one solution if the stored identifier on the RFID tag is unique and not modifiable by third parties. Normally, the ID numbers are already permanently programmed in by the chip manufacturers during production. Even at this stage, a misuse requires great criminal effort. Furthermore, an RFID tag must be permanently connected to the product 3 for a secure plagiarism protection.

On the basis of the prior art according to FIG. 2, a checking system then reaches its limits if, for example, the checking device is not able to verify a response 8 calculated and delivered back by the product 3, because the checking device has no access to the required cryptographic keys. Equally disadvantageously, the status may be that the checking device has a valid, correct key, but no software to verify the response.

If a plagiarism protection check is to be carried out, the corresponding checking device 2, in most cases a reading device, must be equipped on the hardware and software side in such a way as to process the response for a product to be checked that, for example, is permanently connected to an RFID tag and transmits a response 8 in a challenge-response method.

With a global web service proposed, a plagiarism protection service 1 is designed in such a way that a calculation of the challenge 7, a verification of the response 8 for the reading device 2 and a transfer of the verification of the response 8 to a third-party body with authorization for plagiarism protection checking are provided. It is necessary for the devices to be able to operate a web interface via that the global web service may be accessed.

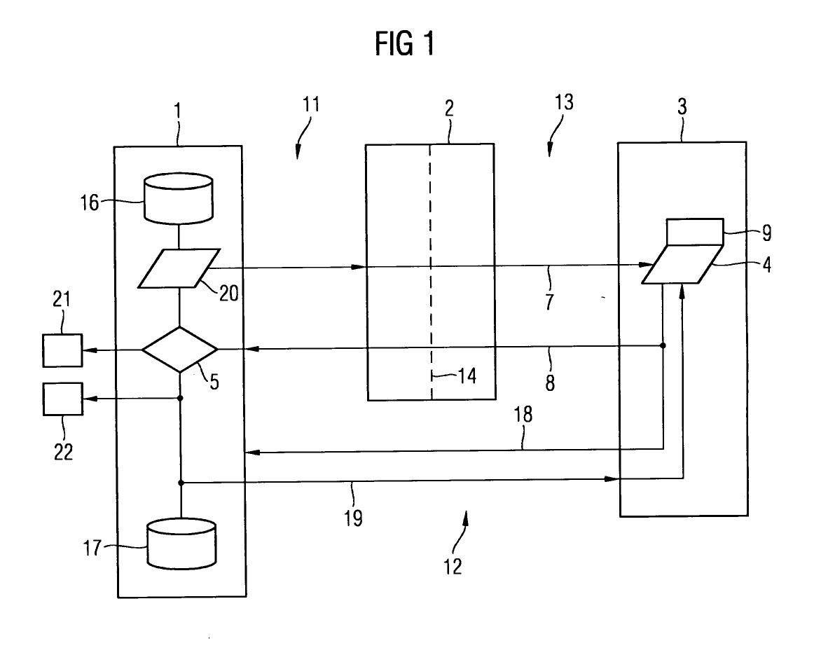

FIG. 1 shows the plagiarism protection service 1 that is set up as a web service. In order to use the web service, a web interface 11 is provided via which the challenge 7 is routed via the reading device 2 and further via the checking interface 13 to the product 3 to be checked. Furthermore, the response 8 calculated on the product 3 is routed in the opposite direction to the plagiarism protection service 1. The verification 5 evaluates the response 8. The categorization of the product 3 to be checked as “false” 21 or as “true” 22 is output. The categorization of the product 3 to be checked may not only be displayed on the plagiarism protection service, but may also be transferred in an integrity-protected manner to the reading device 2 and displayed there.

The generation 4 of the response 8 takes place on the product 3, via a direct connection to the product, such as, for example an RFID tag. The system shown in FIG. 1 is based on challenge 7-response 8 methods. A protocol conversion 14 takes place within the checking device 2. The storage media 16, 17 are used for the temporary storage of data for the time-delayed plagiarism protection verification.

On the other hand, a product 3 to be checked may also communicate directly with the plagiarism protection service 1 via a web access, a web interface 12. For this purpose, a verification 18 of the plagiarism protection service 1 is carried out by the product 3 to be checked. Following the verification, software 19 may be transferred from the plagiarism protection service 1 to the product 3 to be checked, so that software is available for a generation of a response 8.

It is to be understood that the elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

While the present invention has been described above by reference to various embodiments, it may be understood that many changes and modifications may be made to the described embodiments. It is therefore intended that the foregoing description be regarded as illustrative rather than limiting, and that it be understood that all equivalents and/or combinations of embodiments are intended to be included in this description.

1. A method for plagiarism protection for cryptographic challenge-response methods, wherein an originality check is carried out for products that require a secret symmetric or a private asymmetric key on the product side, the method comprising:
carrying out a calculation of a challenge for a product to be checked by a plagiarism protection service set up as a web service,
carrying out a verification of a response from the product by the plagiarism protection service,
transferring the result of the verification from the plagiarism protection service to a checking device authorized for plagiarism checking
receiving an authentication of the plagiarism protection service from the product; and
transferring online directly software from the plagiarism protection service to the product for calculating the response.

2. The method as claimed in claim 1, wherein the result of the verification is transferred in an integrity-protected manner to the checking device.

3. The method as claimed in claim 1, wherein the result of the verification of the response is transferred via an authenticated communication connection to the checking device.

4. The method as claimed in claim 1, wherein, along with the transfer of the verification result, further data is transmitted to the checking device.

5. The method as claimed in claim 1, wherein provided keys are retained in a memory area of the checking device protected against unauthorized reading.

6. The method as claimed in claim 1, wherein the calculation of a challenge is performed by the plagiarism protection service immediately at the request of the checking device or in advance.

7. The method as claimed in claim 1, wherein cryptographic keys are provided in a repository of the checking device.

8. The method as claimed in claim 7, wherein an authentication and authorization of the plagiarism protection service vis-à-vis the repository is carried out for symmetric methods.

9. The method as claimed in claim 1, wherein the response is transferred directly to the plagiarism protection service and verified.

10. The method as claimed in claim 1, wherein the response is temporarily stored via the checking device and the response is transferred from the checking device via data media to the plagiarism protection service and the response is verified at time intervals by the plagiarism protection service.

11. The method as claimed in claim 1, wherein the checking device has online access to the plagiarism protection service, and the checking device uses the plagiarism protection service to to generate a response.

12. The method as claimed in claim 1, wherein an authenticity of the plagiarism protection service and a downloaded software is carried out by the product to be checked in order to generate the response.

13. The method as claimed in claim 1, wherein a portal is made available by the plagiarism protection service for the checking device, via which access is available to previously carried out plagiarism protection checks.

14. The method as claimed in claim 1, wherein cryptographically secured REID chips are used and no software is required for the checking device.

15. The method as claimed in claim 1, wherein an originality check is incorporated into a secure environmental check for the product.

16. The method as claimed in claim 1, wherein results of the plagiarism check can be retrieved via a web portal interface.

17. The method as claimed in claim 1, wherein the plagiarism protection check is carried out by contractors.

18. An arrangement for plagiarism protection, wherein an originality check is carried out for products which require a secret symmetric or a private asymmetric key on the product side, wherein a plagiarism protection service is set up as a web service, the arrangement comprising:
the plagiarism protection service; and
a checking device authorized for plagiarism checking,
wherein the plagiarism protection service:
calculates a challenge for a product to be checked,
verifies the response from the product,
transfers the verification result to the checking device,
receives an authentication of the plagiarism protection service from the product; and
transfers online directly software to the product for calculating the response.

19. A method for plagiarism protection, the method comprising:
routing a challenge from a plagiarism protection web service to a product to be checked via a reading device and checking interface;
calculating a response on the product;
routing the response from the product to the plagiarism protection web service; and
evaluating the response on the plagiarism protection web service.

20. The method as claimed in claim 19, further comprising:
verifying the plagiarism protection service by the product; and
transferring software from the plagiarism protection service to the product such that the software is available on the product for generation of the response.
